(19) United States
(12) Patent Application Publication
(10) Pub. No.: US 2026/0319439 A1
(43) Pub. Date: Oct. 15, 2026

(54) WATCH CASE COMPRISING A DEVICE FOR ATTACHING A ROTATING BEZEL

(71) Applicant: The Swatch Group Research and Development Ltd, Marin (CH)

(72) Inventor: Philipp TSCHUMI, Niederwil (CH)

(73) Assignee: The Swatch Group Research and Development Ltd, Marin (CH)

(21) Appl. No.: 19/560,456

(22) Filed: Mar. 9, 2026

(30) Foreign Application Priority Data
Apr. 14, 2025 (EP) 25170486.2

(51) Int. Cl. G04B 19/28; G04B 37/08

(52) U.S. Cl. CPC G04B 19/283; G04B 37/08

(57) ABSTRACT

A watch case (10) including a crystal (11), a middle case (12), a rotating bezel (13) and a device for attaching the rotating bezel (13) to the middle case (12), wherein the watch case (10) is characterised in that the fastening device of the rotating bezel (13) includes a bearing (14) having rolling elements (140) interposed between a first and a second ring (141, 142), the bearing (14) being secured by the first ring (141) with the middle case, and being secured by the second ring (142) with the rotating bezel (13), such that the rotating bezel (13) has only one degree of rotational mobility.

### CROSS-REFERENCE TO RELATED APPLICATIONS

This application claims priority to European Patent Application No. No 25170486.2, filed on Apr. 14, 2025, the entire contents of which are incorporated herein by reference.

### Technical Field of the Invention

The invention relates to the domain of watchmaking, and concerns in particular a watch case comprising a device for attaching a rotating bezel.

### Technological Background

Some watch cases have a rotating bezel with indications so that a user can place them in a desired angular position. Rotating bezels are typically used in dive watches to indicate a remaining dive time, or to determine the time of a second time zone.

Rotating bezels are attached to the middle case by more or less complex devices. In particular, they have a significant number of components and are tedious to manufacture and assemble.

The invention aims to solve these disadvantages by limiting the number of components of the device for attaching a rotating bezel and by facilitating its assembly and dismantling with the watch case.

### Summary of the Invention

For this purpose, a watch case comprising a crystal, a middle case, a rotating bezel and a device for attaching the rotating bezel to the middle case. The device for attaching the rotating bezel comprises a bearing with rolling elements interposed between a first and a second ring, the bearing being secured by the first ring with the middle case, and being secured by the second ring with the rotating bezel, such that the rotating bezel only has one degree of rotational mobility.

In other words, the first ring is attached to the middle case without any degree of freedom, and the second ring is rotationally integrated with the rotating bezel. Thus, the bearing allows the rotating bezel to be attached to the middle case.

In particular embodiments, the invention can further comprise one or more of the following features, taken separately or in any technically possible combination.

In particular embodiments, the second ring forms a cage with which the rotating bezel cooperates, said second ring having housings receiving the rolling elements, the latter being capable of rolling on a rolling track formed by the first ring.

In particular embodiments, the rolling track has a succession of troughs, the housings having an elastic wall arranged so as to force each rolling element to rest against the rolling track.

In particular embodiments, the second ring cooperates with the rotating bezel by elastic snap-fitting.

In particular embodiments, the second ring comprises, on the one hand, at least one elastically deformable lug engaged with an inner radial tab of the rotating bezel, and on the other hand, a radial protrusion housed in an inner recess of the rotating bezel having a shape corresponding to that of the radial protrusion.

In particular embodiments, the rotating bezel has a radial lip extending towards the inside of the case, so as to cover the bearing in order to seal the housings in which the rolling elements are arranged.

In particular embodiments, the rotating bezel comprises a base by which it is attached to the bearing, said base being provided with the radial lip, the rotating bezel further comprising a cladding disc attached to the base of the rotating bezel.

In particular embodiments, the bearing is attached to the middle case by press-fitting or bonding the first ring to the middle case.

In particular embodiments, the bearing is attached to the middle case via a fastening ring having a first portion pressing against the bearing, and a second portion connected to the first portion and having a tubular shape by which the fastening ring is attached to the middle case.

In particular embodiments, the first portion forms a shoulder with the second portion, which cooperates with the first ring of the bearing.

In particular embodiments, the middle case comprises an axial bearing element against which the first portion of the fastening ring is supported.

In particular embodiments, the first portion of the fastening ring has at least two notches, the middle case and the fastening ring being configured to be fastened to each other by means of a screw-nut connection.

In particular embodiments, the first portion of the fastening ring has at least two notches, the middle case and the fastening ring being configured to be fastened to each other by way of a bayonet connection.

In particular embodiments, each housing has, in addition to the elastic wall, a rigid wall arranged so as to prevent the rolling elements from rolling in the rolling track when the rotating bezel is driven in a first rotational direction, the elastic wall being arranged so as to allow the rolling elements to roll in the rolling track when the rotating bezel is driven in a second rotational direction opposite to the first rotational direction.

### BRIEF DESCRIPTION OF THE FIGURES

Other features and advantages of the invention will become apparent from the following detailed description, given by way of non-limiting example, with reference to the attached drawings in which:

FIG. 1 schematically depicts a cross-sectional view of a watch case comprising a device for attaching a rotating bezel according to an embodiment of the present invention, and a detail view of the device for attaching a rotating bezel,

FIG. 2 depicts another embodiment of a watch case according to the invention and a detail view of its device for attaching a rotating bezel,

FIG. 3 depicts an exploded view of the watch case according to FIG. 2 and two detail views depicting, respectively, a housing of a rolling element and the device for attaching a rotating bezel,

FIG. 4 depicts a detail view of the housing of FIG. 3 according to another embodiment.

It should be noted that the figures are not necessarily drawn to scale for clarity reasons.

### DETAILED DESCRIPTION OF THE INVENTION

The present invention relates to a watch case 10 comprising, in a manner known to the person skilled in the art, a crystal 11, a middle case 12 in which the crystal 11 is housed, and a rotating bezel 13.

The case 10 has a central axis parallel to the z-direction and the crystal 11 extends in an osculatory plane parallel to the x-direction. The direction z defines an axial direction and the direction x defines a radial direction.

The case 10 has a device for attaching the rotating bezel 13 to the middle case 12, comprising a bearing 14 including rolling elements 140 interposed between a first and a second ring 141 and 142. The rolling elements 140 can be balls or rollers.

The bearing 14 is attached to the middle case 12 by the first ring 141, and is attached to the rotating bezel 13 by the second ring 142, such that the rotating bezel 13 has only one degree of rotational mobility. Indeed, the bearing 14 is configured so as to prevent any translation of the rotating bezel 13, as described in more detail in the remainder of the text.

In the embodiment shown in FIG. 1, the bearing 14 is attached directly to the middle case 12 by press-fitting or bonding the first ring 141 to the middle case 12.

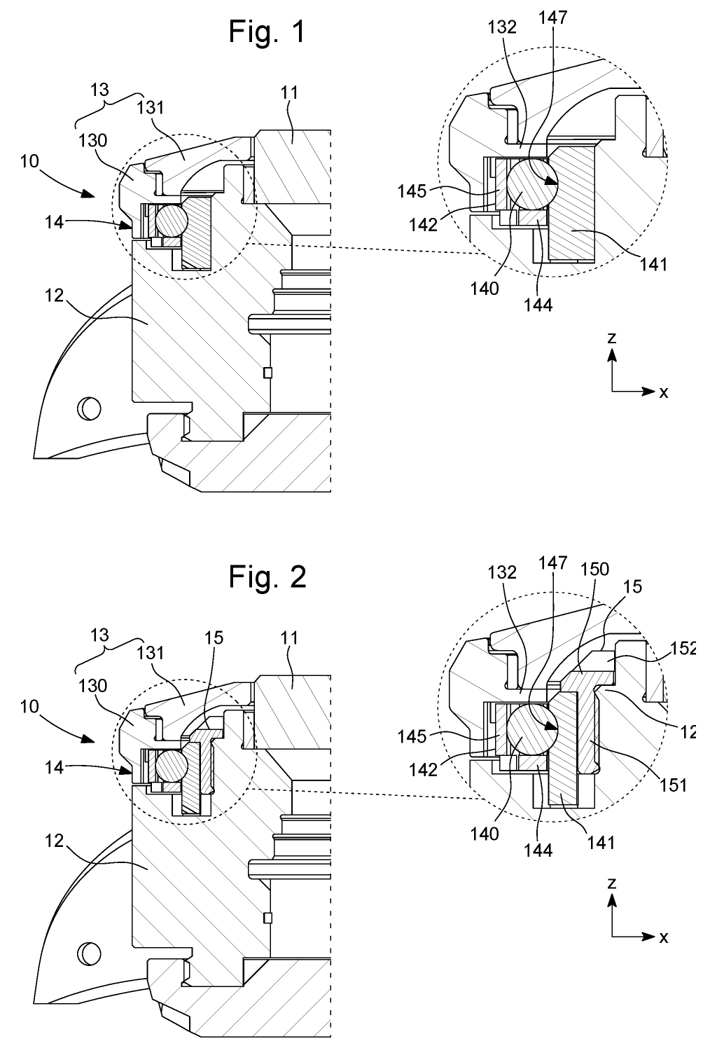

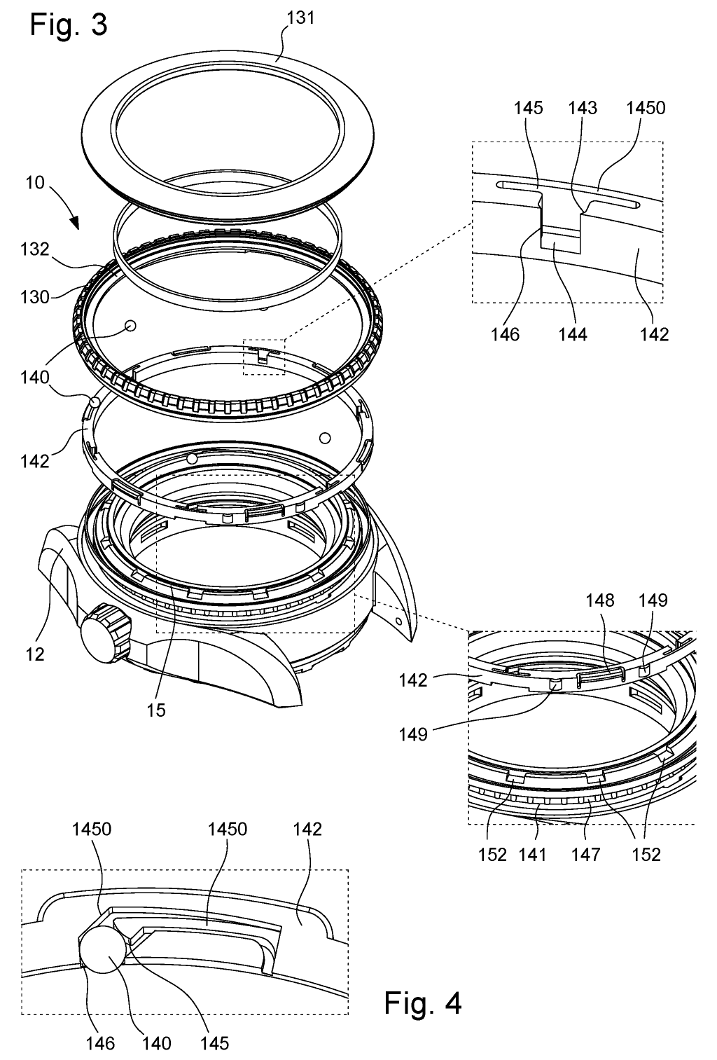

As visible in particular in FIG. 3, the second ring 142 forms a cage comprising housings receiving the rolling elements 140. Each of the housings extends axially between an axial opening 143 and a bottom 144, visible in FIGS. 1 and 2, respectively allowing a rolling element 140 to be inserted into the housing and supporting the latter. The housings extend radially between an elastic wall 145 and a radial opening 146 allowing the rolling elements 140 to roll on a rolling track 147 formed by the first ring 141.

The rolling track 147 has the shape of a groove, as shown in the detail views of FIGS. 1 and 2. In particular, in the embodiments of the invention depicted in these figures, the rolling elements 140 are balls and the rolling track 147 has the shape of a circular arc.

Advantageously, as shown in the detail view of the exploded view of FIG. 3, the bottom of the groove forming the rolling track 147 comprises a succession of hollows so as to index the rotating bezel 13 in several distinct angular positions when it rotates with respect to the middle case 12. The rotating bezel 13 therefore occupies an indexed position when the rolling elements 140 are housed in the hollows of the rolling track 147.

In order to ensure this indexing, the elastic wall 145 of each housing is arranged so as to force each rolling element 140 to rest against the rolling track 147. Between two indexed positions, the elastic wall 145 is therefore deformed by the rolling element 140 between two hollows of the rolling track 147. More specifically, this deformation is radial insofar as the rolling track 147 is radially oriented. In the embodiment depicted in the view of FIG. 3, the elastic wall 145 is formed between two ends of an elastic blade 1450, the two ends being connected to a body of the second ring 142.

The rolling track 147, due to its groove shape, makes it possible to axially hold the second ring 142, i.e. to immobilise it in translation with respect to the middle case 12.

In the embodiment shown in FIG. 4, the housings are configured to allow the rolling elements 140 to roll in the rolling track 147 only in one direction. In particular, each housing has, in addition to the elastic wall 145, a rigid wall 1420, i.e., not elastically deformable, against which the rolling element 140 is intended to rest. More specifically, the elastic wall 145 is arranged so as to allow rolling of the rolling elements 140 in the rolling track 147 and therefore rotation of the rotating bezel 13, and the rigid wall 1420 is arranged so as to prevent rolling of the rolling elements 140 in the rolling track 147 and therefore rotation of the rotating bezel 13. As can be seen in FIG. 4, the rigid walls 1420 and elastic walls 145 form two inclined panels with respect to the radial direction.

Indeed, when a torque is applied to the rotating bezel 13 by a user so as to rotate the latter in a first direction, for example clockwise, the second ring 142 causes the rolling element 140 to move so that it partially exits the hollow of the rolling track 147 in which it is housed, until it abuts the rigid wall 1420. Since the rolling element 140 cannot be completely removed from the hollow in which it is housed, it blocks the rotation of the second ring 142 and therefore of the rotating bezel 13 in the first direction.

When torque is applied to the rotating bezel 13 by a user so as to rotate it in a second direction, opposite the first direction, for example counterclockwise, the second ring 142 causes the rolling element 140 to move so that it fully exits the hollow of the rolling track 147 in which it is housed, deforming the elastic wall 145. The rotation of the second ring 142, and therefore of the rotating bezel 13, is therefore allowed in the second direction. During this rotation, the rolling element 140 is forced by the elastic wall 145 to be housed in the successive hollows of the rolling track 147. In the embodiment depicted in FIG. 4, the elastic wall 145 is formed by a free end of an elastic blade 1450, the other end of the elastic blade 1450 being connected to the body of the second ring 142.

As noted above, the rotating bezel 13 is fixed in translation with respect to the middle case 12 by means of the second ring 142. In particular, the second ring 142 cooperates with the rotating bezel 13 by elastic snap-fitting. For this purpose, the second ring 142 may include elastically deformable lugs 148, each engaged with an inner radial tab of the rotating bezel 13. In order to connect the second ring 142 and the rotating bezel 13 in rotation, the second ring 142 may include one or more radial protrusions 149, each engaged in an inner recess of the rotating bezel 13 having a shape corresponding to that of the radial protrusion 149. These radial protrusions 149 are shown in the exploded view of FIG. 3.

The rotating bezel 13 is preferably made of two parts, including a base 130 by which it is attached to the bearing 14, and a cladding disc 131 attached to the base 130, for example by means of press-fitting or elastic fitting. As seen in FIGS. 1 and 2, the cladding disc 131 overlies a portion of the bearing 14 so as to hide it from the user's view.

Advantageously the rotating bezel 13, and in particular the base 130, has a radial lip 132 extending towards the inside of the case 10, so as to cover the bearing 14 in order to seal the housings in which the rolling elements 140 are arranged, and in particular the axial opening 143. In other words, the radial lip 132 makes it possible to prevent the rolling elements 140 from exiting their respective housings.

In the embodiment depicted in FIG. 2, the bearing 14 is attached to the middle case 12 via a fastening ring 15. The fastening ring 15 has a first portion 150 resting against the bearing 14. More specifically, the first portion 150 forms a shoulder with a second portion 151, and this shoulder cooperates in abutment with the first ring 141 of the bearing 14.

In addition, the middle case 12 comprises an axial bearing element 120 against which the first portion 150 of the fastening ring 15 is supported. As seen in FIG. 2, the fastening ring 15 therefore has a section in the shape of a T.

The second portion 151 has a tubular shape by which the fastening ring 15 is attached to the middle case 12. More precisely, this second portion 151 is interposed between the middle case 12 and the bearing 14, in particular between the middle case 12 and the first ring 141 of the bearing 14.

The fastening ring 15 can be fastened by screwing or by a bayonet connection. For this purpose, the first portion 150 may have at least two notches 152 so that it can be rotated by a dedicated tool. The notches 152 are, for example, regularly distributed over the first portion 150.

In order to assemble the device for attaching the rotating bezel 13 to the case 10 according to the present invention, it is necessary first to fit the crystal 11 into the middle case 12 and to attach the first ring 141 to the middle case 12. The first ring 141 is press-fitted or glued directly onto the middle case 12, or it is then attached to the middle case 12 via the fastening ring 15. The second ring 142 is then engaged around the first ring 141, then the rolling elements 140 are arranged in the housings. Thanks to the elastic walls 145 of the second ring 142 causing the rolling elements 140 to fit in the groove shape of the rolling track 147, axial holding of the second ring 142 on the first ring 141 is ensured.

It is also possible to mount on the middle case 12 an assembly consisting of the first ring 141, the second ring 142 and the rolling elements 140 arranged in the housings, then attach the first ring 141 with the fastening ring 15 if applicable.

Thereafter, the rotating bezel 13 is assembled to the second ring 142. More precisely, the base 130 can be snapped onto the second ring 142, then secondly the cladding disc 131 is attached to the base 130, or the cladding disc 131 can be attached to the base 130 first and the thus formed assembly is snapped onto the second ring 142.

More generally, it should be noted that the methods of implementation and embodiments considered above have been described by way of non-limiting examples, and that other variants are therefore conceivable.

1. A watch case (10) comprising a crystal (11), a middle case (12), a rotating bezel (13) and a device for attaching the rotating bezel (13) to the middle case (12), wherein the watch case (10) is characterised in that the fastening device of the rotating bezel (13) comprises a bearing (14) comprising rolling elements (140) interposed between a first and a second ring (141, 142), wherein the bearing (14) is secured by the first ring (141) with the middle case (12), and secured by the second ring (142) with the rotating bezel (13), such that the rotating bezel (13) has only one degree of rotational mobility, the second ring (142) forming a cage with which the rotating bezel (13) cooperates, said second ring (142) comprising housings receiving the rolling elements (140), the latter being capable of rolling on a rolling track (147) formed by the first ring (141), the rolling track (147) having a succession of hollows, the housings having an elastic wall (145) arranged so as to force each rolling element (140) to rest against the rolling track (147).

2. The watch case (10) according to claim 1, wherein the second ring (142) cooperates with the rotating bezel (13) by elastic snap-fitting.

3. The watch case (10) according to claim 2, wherein the second ring (142) comprises, on the one hand, at least one elastically deformable lug engaged with an inner radial tab of the rotating bezel (13), and on the other hand, a radial protrusion (149) housed in an inner recess of the rotating bezel (13) having a shape corresponding to that of the radial protrusion (149).

4. The watch case (10) according to claim 1, wherein the rotating bezel (13) has a radial lip (132) extending towards the inside of the case (10), so as to cover the bearing (14) in order to seal the housings in which the rolling elements (140) are arranged.

5. The watch case (10) according to claim 4, wherein the rotating bezel (13) comprises a base (130) by which it is attached to the bearing (14), said base being provided with the radial lip (132), the rotating bezel (13) further comprising a cladding disc (131) attached to the base (130) of the rotating bezel (13).

6. The watch case (10) according to claim 1, wherein the bearing (14) is secured to the middle case (12) by press-fitting or bonding the first ring (141) to the middle case (12).

7. The watch case (10) according to claim 1, wherein the bearing (14) is attached to the middle case (12) via a fastening ring (15) having a first portion (150) resting against the bearing (14), and a second portion (151) connected to the first portion (150) and having a tubular shape by which the fastening ring (15) is attached to the middle case (12).

8. The watch case (10) according to claim 7, wherein the first portion (150) forms a shoulder with the second portion (151), which cooperates with the first ring (141) of the bearing (14).

9. The watch case (10) according to claim 7, wherein the middle case (12) comprises an axial bearing element (120) against which the first portion (150) of the fastening ring (15) is supported.

10. The watch case (10) according to claim 7, wherein the first portion (150) of the fastening ring (15) has at least two notches (152), the middle case (12) and the fastening ring (15) configured to be fastened to each other by means of a screw-nut connection.

11. The watch case (10) according to claim 7, wherein the first portion (150) of the fastening ring (15) has at least two notches (152), the middle case (12) and the fastening ring (15) being configured to be fastened to each other by way of a bayonet connection.

12. The watch case (10) of claim 1, wherein each housing has, in addition to the elastic wall (145), a rigid wall (1420) arranged so as to prevent the rolling elements (140) from rolling in the rolling track (147) when the rotating bezel (13) is driven in a first rotation direction, the elastic wall (145) being arranged to allow the rolling elements (140) to roll in the rolling track (147) when the rotating bezel (13) is driven in a second rotational direction opposite to the first rotational direction.
